(19) United States
(12) Patent Application Publication
(10) Pub. No.: US 2003/0102632 A1
(43) Pub. Date: Jun. 5, 2003

(54) Oil seal journal texturing and method thereof

(76) Inventors: Oprea Duta, Fort Thomas, KY (US); Scott Moulis, Maysville, KY (US); Robert A. Bauer, Cold Spring, KY (US); Michael L. Lewis, Maysville, KY (US)

Correspondence Address: HARNESS, DICKEY & PIERCE, P.L.C., P.O. BOX 828, BLOOMFIELD HILLS, MI, 48303, US

(21) Appl. No.: 09/998,483

(22) Filed: Nov. 30, 2001

(51) Int. Cl. F16J 15/16

(52) U.S. Cl. 277/500

(57) ABSTRACT

A shaft has a seal journal with a plurality of raised spherical bumps. These microscopic spherical bumps provide a smooth, edge-free contact surface for the seal which is positioned around the seal journal of the shaft. The valleys or spaces between these bumps serve to retain lubricant, thereby promoting hydrodynamic lubrication between the seal and seal journal, reducing friction and reducing or eliminating wear on the seal.

### FIELD OF THE INVENTION

The present invention generally relates to journal texturing, and more specifically, to texturing an oil seal journal to provide a raised contour.

### BACKGROUND OF THE INVENTION

Many devices, conventionally, utilize a housing filled with fluid or lubricant and shafts passing through the wall of the housing to drive or be driven by an external component. Internal to the housing is a gear set or other mechanical device that modifies the rotational energy, torque or speed supplied from one shaft to another shaft. Such devices must be fluidly sealed from the external environment to ensure that contaminants do not enter the housing nor does fluid leak from the housing to the external environment. However, with the use of rotating shafts in such an arrangement, it is difficult to seal the housing as the rotation of a shaft with respect to a fixed housing wall requires some space between. To aid in fluidly sealing this space, fluid seals are positioned between the shaft and wall. Typical fluid seals are donut-like with a through bore to press against the seal area of the shaft and have an outer surface that engages with an aperture formed in the housing. As a result, the shaft rotates and slides against the fluid seal and the fluid seal presses against the seal area of the shaft to form a barrier between the inside of the housing and the external environment. However, as rotation of the shaft against the seal is resisted by friction, energy is lost to heat due to this resistance. Moreover, the seal and shaft can be worn and damaged due to this friction. As a result, seals and shafts must be replaced which increases labor and maintenance costs and creates downtime.

To address this problem, seal areas of shafts are plunge ground to create a relatively smooth surface and reduce the frictional resistance between the seal and the seal area on the shaft. Plunge grinding also removes the “threading” effect of the rough turning operation that preceded. However, plunge grinding creates a surface texture containing a series of microscopic peaks and valleys, the size and depth of which is dependent upon the grit of the grinding wheel employed (See FIG. 13). The sharp edges of these “peaks” have the undesirable effect of gradually wearing away the seal lips.

Research has been performed in an attempt to find alternate ways of reducing friction and seal wear in lieu of or in addition to plunge grinding. As reported in the SAE Technical Paper Series in an article entitled A Friction-Reducing Shaft Surface for Use With Standard Radial Sharp Lip Oil Seals, one possible method of friction reduction is accomplished by shot peening the seal area on the shaft. According to this publication, shot peening is applied to the surface of the seal area on the shaft at a predefined angle. In addition, a specified diameter of shot is used. As a result, microscopic “pockets” are created on the surface of the shaft which enhance hydrodynamic lubrication, thereby reducing friction between the shaft and seal. While this process does provide these benefits, some drawbacks still exist. Specifically, the surface texture created by this process features randomly located “dimple-like” depressions separated by raised “plateaus” with potentially sharp corners which can accelerate seal wear (See FIG. 14). In addition, as the seal area of the shaft is typically a very narrow band on the shaft, applications of shot peening can extend outward beyond the seal area to other undesirable regions such as bearing and gear surfaces. The present invention is developed in light of these and other drawbacks.

### SUMMARY OF THE INVENTION

To overcome these and other drawbacks, a shaft is provided having a seal area with a plurality of spherical bumps positioned thereon. The plurality of spherical bumps present no sharp edges to the seal and the depressions between these bumps serve to retain lubricant, thereby promoting hydrodynamic lubrication, reducing energy losses due to friction and reducing or eliminating wear on the seal and the shaft.

In another aspect, a speed reducer is provided having a shaft with a seal area that has a plurality of spherical bumps positioned thereon. A seal is positioned between the seal area and an aperture in the housing to seal an internal environment of the housing from an external environment of the housing while allowing the shaft to rotate.

In another aspect, a method for forming the plurality of spherical bumps on the seal area of the shaft is provided. The method includes the steps of forming a plurality of spherical indentations into a cylindrical die or pair of cylindrical dies, pressing the dies against a seal area of a shaft, while rotating the dies to form the plurality of spherical bumps on the surface of the seal area of the shaft.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a wall, shaft and shaft seal using a shaft seal area having a raised texture according to the present invention;

FIG. 2 is a perspective view of a seal surface of a shaft having a raised texture according to the present invention;

FIG. 3A is a schematic view of a process for applying a raised texture to a shaft seal area according to the present invention;

FIG. 3B is a schematic view showing a process for applying a raised texture to a shaft seal according to the present invention;

FIG. 3C is a schematic view of a process for applying a raised texture to a shaft seal surface according to the present invention;

FIG. 4 is a perspective view of a die being peened to create spherical indentations according to the present invention;

FIG. 5 is a perspective view of the surface of a shot peened die according to the present invention;

FIG. 6 is a side view of a shaft having seal areas with a raised texture according to the present invention;

FIG. 7 is a speed reducer having shafts with seal areas with raised textures according to the present invention;

FIG. 8 is a cross-sectional view of a shaft and seal according to the present invention;

FIG. 9 is a perspective view of the formation of dies for applying a raised texture according to the present invention;

FIG. 10 is a cross-sectional view of dies forming a raised texture according to the present invention;

FIG. 11 is a cross-sectional view of dies forming a raised texture according to the present invention;

FIG. 12 is a cross-sectional view of dies forming a raised texture according to the present invention;

FIG. 13 is a diagrammatical view of the surface of a journal area according to the prior art;

FIG. 14 is a diagrammatical view of the surface of a journal area according to the prior art;

FIG. 15 is a diagrammatical view of the surface of a journal area according to the present invention; and

FIG. 16 is a side view of a shaft with the surface of a journal area according to the present invention.

### DETAILED DESCRIPTION OF THE PREFERRED EMBODIMENTS

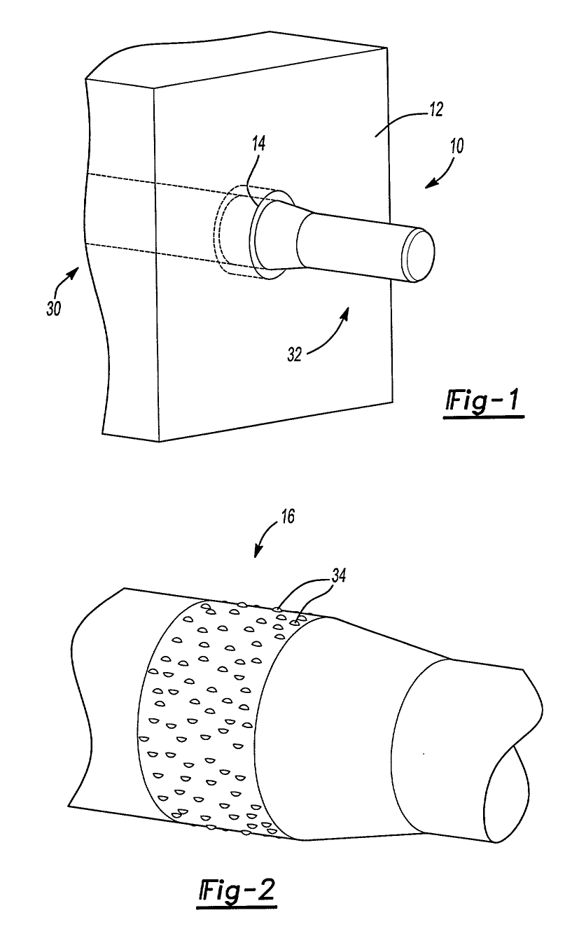

Referring now to FIG. 1, a shaft 10 is shown passing through an aperture in a wall 12. Shaft 10 is separated from the internal diameter of the aperture by seal 14. Wall 12 is a wall of an enclosure or housing (as will be described in greater detail) that separates an internal environment 30 from an external environment 32. Preferably, the housing supports a gear set or other known mechanical device that changes energy, torque or the rotational speed relationship between shafts entering and exiting the housing such as in a speed reducer. However, it is understood that wall 12 can be any barrier having a shaft passing therethrough that requires the area between the shaft and barrier to be sealed.

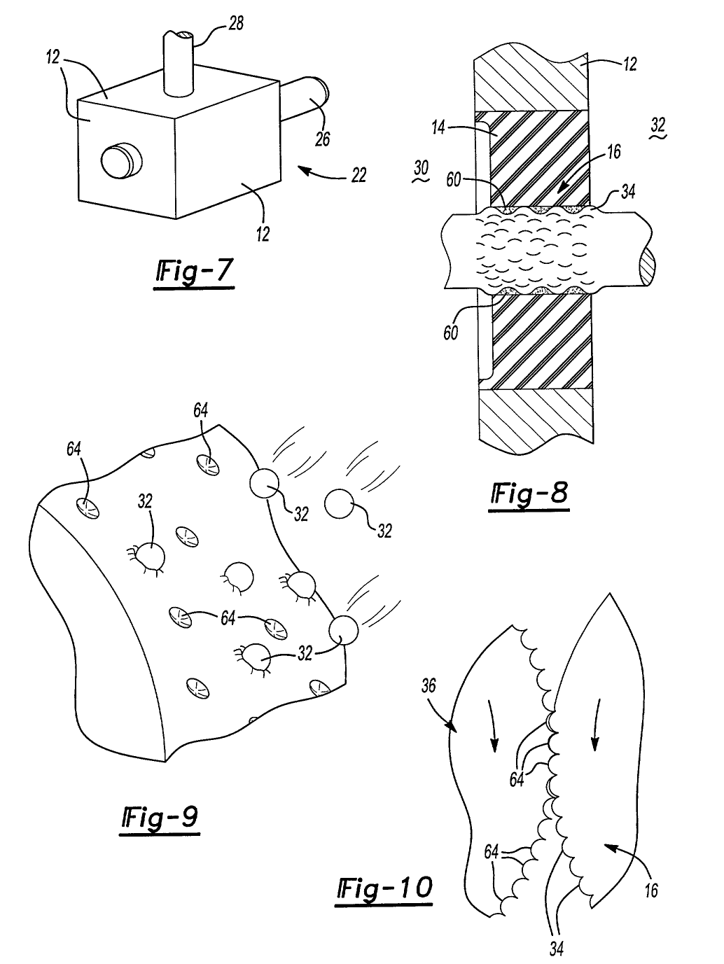

In FIG. 6, shaft 10 is shown in greater detail. Here, shaft 10 is generally cylindrical in shape and has two seal journals 16 and two bearing journals 18. In addition, shaft 10 has a gear journal 20. The gear journal 20 acts to press against an internal diameter of a gear bore to support the gear. Likewise, bearing journals 18 act to press against the internal diameter of bearings to support those bearings. As a result, the bearing journals 18 allow shaft 10 to be rotatably mounted within the housing 22 (see FIG. 7). Thus, shaft 10 can be rotated with respect to housing 22 to thereby drive or be driven by a gear mounted on gear journal 20. As shown in FIG. 7, shafts 26 and 28 (which will be described in greater detail) having the same design as that described for shaft 10, can be positioned in housing 22. Bearings positioned around bearing journals 18 rotatably support the shafts, while seals positioned around seal journals 16 seal respective ends of the shaft that pass through walls 12 such that the internal environment of the housing does not communicate with the outside environment of the housing.

As shown in FIG. 7, wall 12 is one wall of a housing structure preferably for a speed reducer 24. As shown in FIG. 7, speed reducer 24 includes a housing structure 22 having walls 12. Input shaft 26 is positioned through opposite walls 12. The shaft 26 may rotate in the wall 12. Likewise, output shaft 28 is rotatably mounted by opposite walls 12. Both input shaft 26 and output shaft 28 are similar in design to described input shaft 10. Likewise, both input shaft 26 and output shaft 28 pass through walls 12 in a same manner as that described in FIG. 1. Gearing is contained within housing structure 22 and is mounted on input shaft 26 and output shaft 28. The gearing provides a different rotational relationship between input shaft 26 and output shaft 28.

As illustrated in FIG. 1, walls 12 serve to differentiate between the internal environment 30, inside housing structure 22, and the external environment 32. The internal environment, protected by housing structure 22, houses critical components such as bearings, gears and lubricant. As a result, it is critical that the internal environment 30 be fluidly sealed from the external environment 32. Accordingly, the seal protects the internal environment 30 from external contamination and prevents lubricant from leaking from the internal environment 30 to the external environment 32.

To fluidly seal the internal environment 30 from the external environment 32, seal 14 is positioned between seal journal 16 and wall 12. Shaft 10 in wall 12 slides against seal 14 during rotation. Some lubricant from within housing structure 22 passes along the inner face between seal 14 and seal journal 16. This ensures that the amount of friction is reduced.

Referring now to FIG. 2, seal area 16 is described in greater detail. Seal area 16 includes a plurality of spherical bumps 34 or raised portions which form a raised texture on seal area 16. Raised bumps 34 are preferably hemispherical in nature.

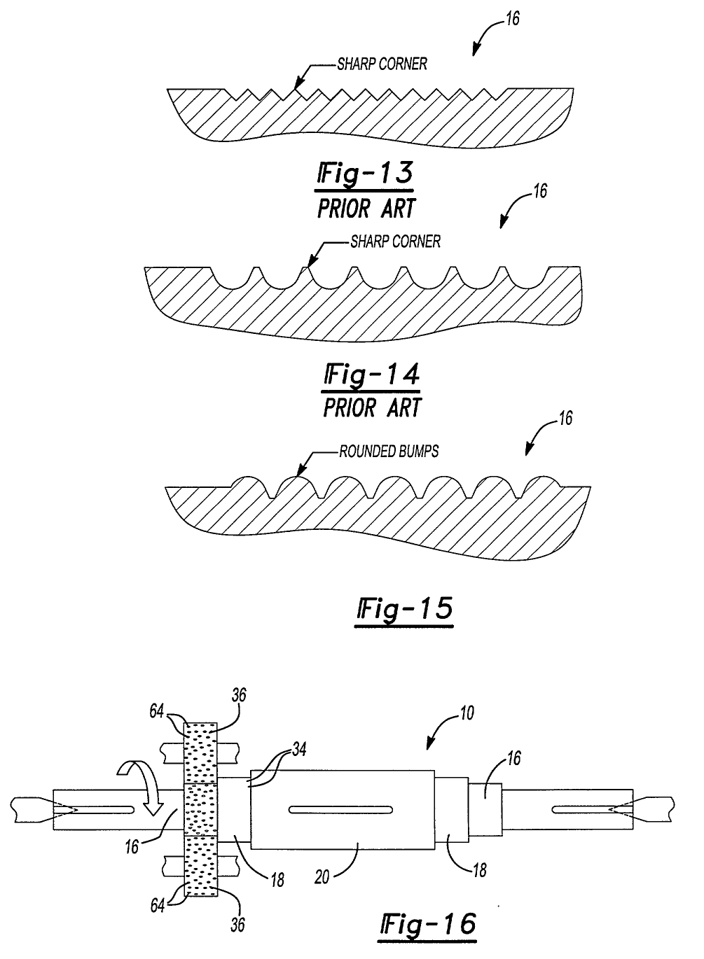

As shown in FIG. 8, spherical bumps 34 provide gaps 60 that collect lubricant from the inside of housing structure 22. The lubricant is retained in the gaps and supports hydrodynamic lubrication between the shaft 10 and the seal 14. Moreover, as shown in FIG. 15, the addition of the rounded surfaces eliminates the sharp edges as found in the prior art such as illustrated FIGS. 13 and 14. This reduces or eliminates wear on the seal itself.

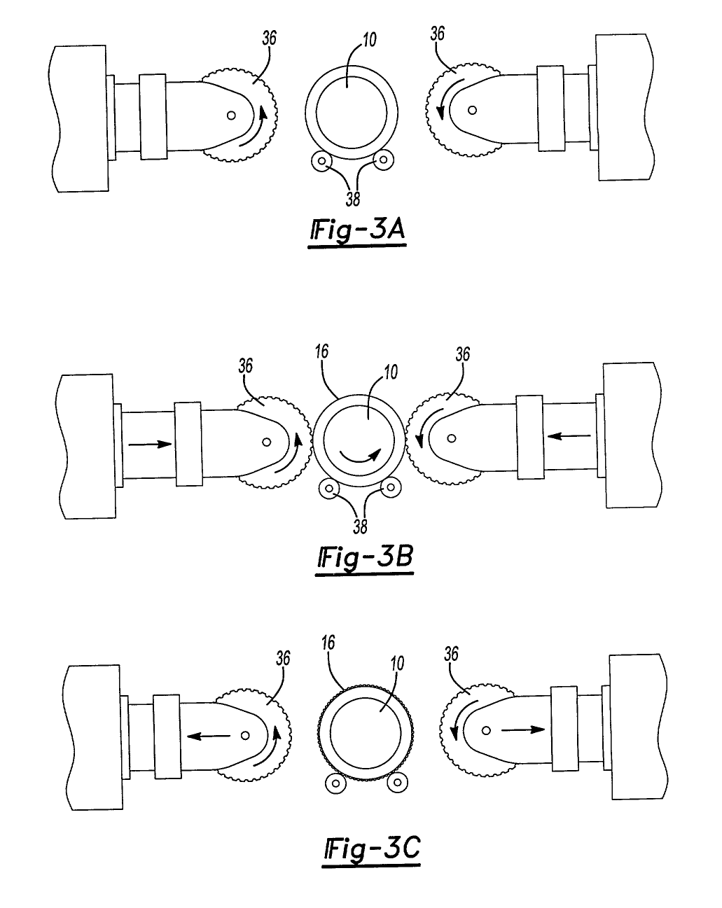

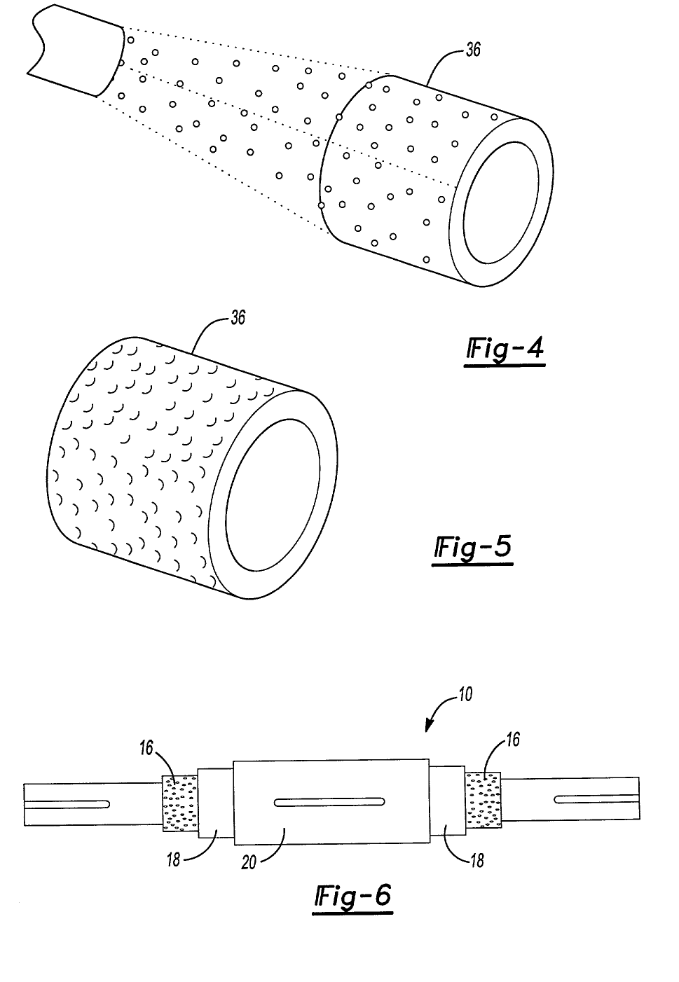

Referring now to FIGS. 3A-3C, and 4, a method of forming spherical bumps 34 onto the seal journal 16 is shown and described. In FIG. 3A, shaft 10 is positioned on rollers 38 between dies 36. As illustrated in FIG. 4, dies 36 are formed by shot peening, or other known mechanical means of impaling shot, or other material against a metal blank. As illustrated in FIG. 9, particles 62 impact the surface of dies 36 to form spherical indentations 64. These indentations act as small molds to form the raised surface on seal journal 16. Alternatively, the spherical indentations 64 can be formed by an alternate method such as EDM. In such a process, an EDM carbon is manufactured having a plurality of bumps. The EDM carbon is then burned into the die to form the plurality of spherical indentations 64. Alternatively, other methods of formation can be used that include forging, casting, or machining to form spherical indentations 64. In addition, the process to form spherical indentations can also include chemical etching, laser cutting or rolling a die having a plurality of bumps against the dies 36.

In FIG. 3B, dies 36 are pressed against shaft 10 with sufficient force to cause metal deformation at the seal journal 16 in shaft 10. As shown in FIG. 10, the surface of the seal journal 10 is plastically deformed into the indentations 64 of dies 36. As this occurs, the spherical bumps 34 are formed. The spherical bumps 34 have substantially the same convex or external shape as the shot or other material which was used to form the dies 36. The dies 36 are rotated according to the arrow shown in the figure. During this process, shaft 10 may be supported and located by rollers 38 or by center supports engaging shaft 10 as shown in FIG. 16. In FIG. 3C, dies 36 are retracted from shaft 10. As a result, the seal journal 16 is deformed to include spherical bumps 34. In FIG. 5, the inverse impressions in die 36 due to shot peening can generally be seen.

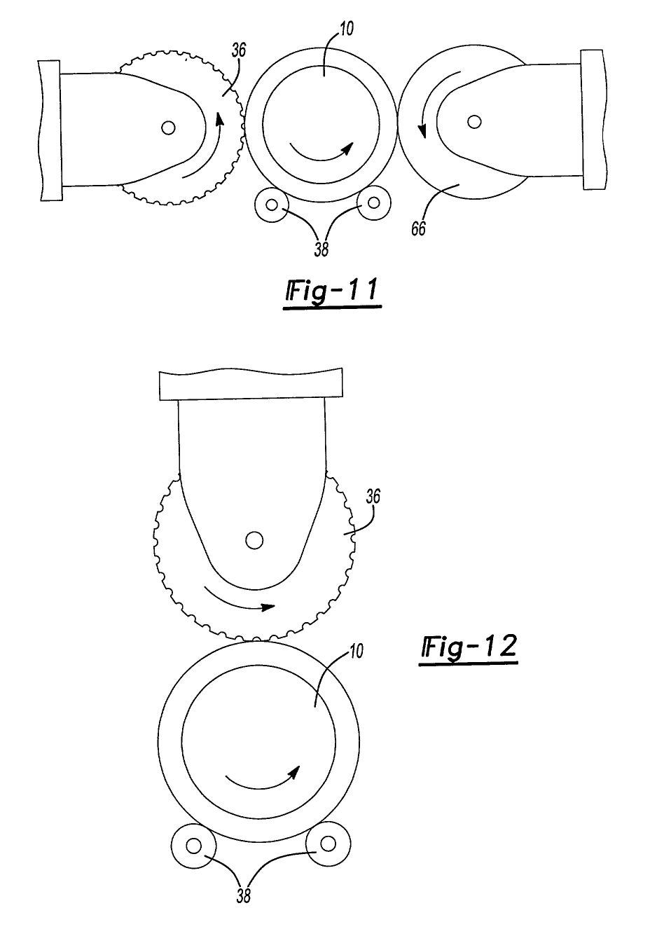

In FIG. 11, another aspect is shown where one of the dies 36 is replaced by a roller 66. Here, only die 36 provides a raised texture on the seal area, while roller 66 supports shaft 10 from moving due to the force from die 36. In FIG. 12, another aspect is shown where die 36 is positioned on top of shaft 10 and the rollers 38 counter the force applied by die 36.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A speed reducer comprising:
a housing;
an input shaft having at least one seal area with a plurality of bumps, the input shaft being positioned through an input aperture in the housing;
an input seal disposed between the seal area of the input shaft and the input aperture in the housing to seal an internal environment of the housing from an external environment of the housing;
an output shaft having at least one output seal area, having a plurality of bumps disposed thereon, the output shaft passing through an output aperture in the housing; and
an output seal disposed between the output aperture in the housing and the output seal area to seal the internal environment of the housing from the external environment of the housing.

2. A method for texturing a seal area of a shaft, the method comprising the steps of:
providing at least one die;
forming a plurality of indentations on an outer surface of the at least one die; and
pressing the die against a seal area of a shaft to form rounded bumps in the seal area.

3. The method as claimed in claim 2, wherein the step of forming is performed by bombarding the at least one die with spherical objects.

4. The method as claimed in claim 3, wherein said bombarding is shot peening.

5. The method as claimed in claim 2, further comprising the step of supporting the shaft on a plurality of rollers before the raised texture die is pressed against the seal area.

6. The method as claimed in claim 5, wherein the plurality of rollers counter force supplied from the die.

7. The method as claimed in claim 5, wherein the at least one die includes two dies on opposite sides of the shaft, wherein the two dies are pressed against the seal area during the step of pressing.

8. The method as claimed in claim 5, further comprising a roller positioned on an opposite side of the shaft from the at least one die, the roller serving to support the shaft during the step of pressing.

9. A shaft comprising:
a seal area; and
a plurality of bumps on the seal area.

10. The shaft as claimed in claim 9, wherein a seal is positioned around the seal area.

11. The shaft as claimed in claim 9, wherein the seal is positioned within an aperture in a housing to seal an internal area of the housing from an external area of the housing.

12. The shaft as claimed in claim 9, further comprising a bearing journal for supporting a bearing.

13. The shaft as claimed in claim 9, further comprising a gear journal for supporting a gear.

14. A wall and shaft assembly comprising:
a wall having an aperture;
a shaft having a seal area with a plurality of bumps, the shaft being positioned through the aperture; and
a seal disposed between the seal area of the shaft and the aperture to seal a first side of the wall from a second side of said wall.

15. The wall and shaft assembly as claimed in claim 14, wherein the shaft further comprises a bearing journal for supporting a bearing.

16. The wall and shaft assembly as claimed in claim 14, wherein the shaft further comprises a gear journal for supporting a gear.
